(19) United States
(12) Patent Application Publication
(10) Pub. No.: US 2025/0314985 A1
(43) Pub. Date: Oct. 9, 2025

(54) ELECTROPHOTOGRAPHIC INK COMPOSITIONS

(71) Applicant: Hewlett-Packard Development Company, L.P., Spring, TX (US)

(72) Inventors: Benjamin Reisman, Nes Ziona (IL); Inna Tzomik, Nes Ziona (IL); Katty Noorany, Nes Ziona (IL); Chen Zigdon, Nes Ziona (IL)

(21) Appl. No.: 18/854,286

(22) PCT Filed: Apr. 8, 2022
(86) PCT No.: PCT/US2022/023962

§ 371 Date: Oct. 4, 2024

(51) Int. Cl. G03G 9/16

(52) U.S. Cl. CPC G03G 9/16; G03G 2215/00801; G03G 2215/0631

(57) ABSTRACT

Described herein is a liquid electrophotographic printing process comprising heating a coating composition comprising a thermoplastic polymer and a liquid carrier to dissolve the thermoplastic polymer in the liquid carrier and form a heated coating solution; and applying the heated coating solution to a liquid electrophotographically printed layer disposed on a substrate. The thermoplastic polymer may be selected from a copolymer of ethylene and an alk-1-ene and a copolymer of ethylene and 50 wt. % or less vinyl acetate; and the liquid carrier may comprise a hydrocarbon, a silicone oil or a vegetable oil. Also described herein are a liquid electrophotographic printing kit comprising a liquid electrophotographic ink composition and a coating composition, as well as a liquid electrophotographic printer.

Electrophotographic printing processes, sometimes termed electrostatic printing processes, typically involve creating an image on a photoconductive surface, applying an ink having chargeable particles to the photoconductive surface, such that they selectively bind to the image, and then transferring the chargeable particles in the form of the image to a print substrate. The chargeable particles are created by grinding pigment particles with particles of chargeable polymer resin.

The photoconductive surface may be on a cylinder and is often termed a photo imaging plate (PIP). The photoconductive surface is selectively charged with a latent electrostatic image having image and background areas with different potentials. For example, an electrostatic ink composition including chargeable particles in a liquid carrier can be brought into contact with the selectively charged photoconductive surface. The chargeable particles adhere to the image areas of the latent image while the background areas remain clean. The image is then transferred to a print substrate (e.g., a polymer substrate) directly or by being first transferred to an intermediate transfer member, which can be a soft swelling blanket, which is often heated to fuse the solid image and evaporate the liquid carrier, and then to the print substrate.

### BRIEF DESCRIPTION OF THE FIGURES

FIG. 1 shows a flow diagram schematically illustrating an example liquid electrophotographic printing process.

FIG. 2 shows a schematic illustration of an example liquid electrophotographic printer.

### DETAILED DESCRIPTION

Before the present disclosure is disclosed and described, it is to be understood that this disclosure is not limited to the particular process steps and materials disclosed herein because such process steps and materials may vary somewhat. It is also to be understood that the terminology used herein is used for the purpose of describing particular embodiments. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “carrier fluid”, “carrier liquid,” “carrier,” “liquid carrier” or “carrier vehicle” refers to the fluid in which pigment particles, resin, charge directors and other additives can be dispersed to form a liquid electrostatic ink composition or liquid electrophotographic ink composition. The carrier liquids may include a mixture of a variety of different agents, such as surfactants, co-solvents, viscosity modifiers, and/or other possible ingredients.

As used herein, “liquid electrostatic ink composition” or “liquid electrophotographic composition” generally refers to an ink composition that is typically suitable for use in an electrostatic printing process, sometimes termed an electrophotographic printing process. It may comprise pigment particles having a thermoplastic resin thereon. The electrostatic ink composition may be a liquid electrostatic ink composition, in which the pigment particles having resin thereon are suspended in a carrier liquid. The pigment particles having resin thereon will typically be charged or capable of developing charge in an electric field, such that they display electrophoretic behaviour. A charge director may be present to impart a charge to the pigment particles having resin thereon.

As used herein, “co-polymer” refers to a polymer that is polymerized from at least two monomers.

As used herein, “melt flow rate”, “melt flow index” or “melt index” generally refers to the extrusion rate of a resin through an orifice of defined dimensions at a specified temperature of, for example, 190° C., and a load of, for example 2.16 kg. Flow rates can be used to differentiate grades or provide a measure of degradation of a material as a result of molding. In the present disclosure, unless otherwise stated, “melt flow rate” is measured per ASTM D1238 Standard Test Method for Melt Flow Rates of Thermoplastics by Extrusion Plastometer, as known in the art. If a melt flow rate of a particular polymer is specified, unless otherwise stated, it is the melt flow rate for that polymer alone, in the absence of any of the other components of the liquid electrostatic ink composition.

As used herein, the “melting point” of a polymer generally refers to the peak in the melting point range as determined by using differential scanning calorimetry (DSC).

The melting point may be determined by, for example, the method using DSC described in ASTM D7138.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity® 140° C., units are mPa·s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrostatic composition.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic printing” or “electrophotographic printing” generally refers to the process that provides an image that is transferred from a photo imaging substrate either directly or indirectly via an intermediate transfer member to a print substrate, such as a paper or a plastic substrate. As such, the image is not substantially absorbed into the photo imaging substrate on which it is applied. Additionally, “electrophotographic printers” or “electrostatic printers” generally refer to those printers capable of performing electrophotographic printing or electrostatic printing, as described above. “Liquid electrostatic printing” is a specific type of electrostatic printing in which a liquid composition is employed in the electrophotographic process rather than a powder toner. An electrostatic printing process may involve subjecting the electrostatic composition to an electric field, for example, an electric field having a field gradient of 50-400 V/μm, or more, in some examples, 600-900V/μm, or more.

As used herein, “NVS” is an abbreviation of the term “non-volatile solids”.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless otherwise stated, wt. % values are to be taken as referring to a weight-for-weight (w/w) percentage of solids in the ink composition, and not including the weight of any carrier fluid present.

Unless otherwise stated, any feature described herein can be combined with any aspect or any other feature described herein.

In an aspect, there is provided a liquid electrophotographic printing process. The liquid electrophotographic printing process may comprise: heating a coating composition comprising a thermoplastic polymer and a liquid carrier to dissolve the thermoplastic polymer in the liquid carrier and form a heated coating solution; and applying the heated coating solution to a liquid electrophotographically printed layer disposed on a substrate.

In some examples, the liquid electrophotographic printing process may comprise: heating a coating composition comprising a thermoplastic polymer and a liquid carrier to dissolve the thermoplastic polymer in the liquid carrier and form a heated coating solution; wherein the thermoplastic polymer is selected from a copolymer of ethylene and an alk-1-ene and a copolymer of ethylene and 50 wt. % or less vinyl acetate; and wherein the liquid carrier comprises a hydrocarbon, a silicone oil or a vegetable oil; and applying the heated coating solution to a liquid electrophotographically printed layer disposed on a substrate.

In some examples, the liquid electrophotographic printing process may comprise: heating a coating composition comprising a thermoplastic polymer and a liquid carrier to dissolve the thermoplastic polymer in the liquid carrier and form a heated coating solution; wherein the thermoplastic polymer has a melting point of 75° C. or less and a melt flow rate of 5 g/10 min or less; and wherein the liquid carrier comprises a hydrocarbon, a silicone oil or a vegetable oil; and applying the heated coating solution to a liquid electrophotographically printed layer disposed on a substrate. In some examples, the thermoplastic polymer may be selected from a copolymer of ethylene and an alk-1-ene and a copolymer of ethylene and 50 wt. % or less vinyl acetate.

In another aspect, there is provided a liquid electrophotographic printing kit. The liquid electrophotographic printing kit may comprise a liquid electrophotographic ink composition; and a coating composition comprising a thermoplastic polymer and a liquid carrier. The thermoplastic polymer may comprise a copolymer of ethylene and an alk-1-ene or a copolymer of ethylene and 50 wt. % or less vinyl acetate. The liquid carrier may comprise a hydrocarbon, a silicone oil or a vegetable oil.

In another aspect, there is provided a liquid electrophotographic printing kit. The liquid electrophotographic printing kit may comprise a liquid electrophotographic ink composition; and a coating composition comprising a thermoplastic polymer and a liquid carrier. The thermoplastic polymer may have a melting point of 75° C. or less and a melt flow rate of 5 g/10 min or less. The liquid carrier may comprise a hydrocarbon, a silicone oil or a vegetable oil.

In a further aspect, there is provided a liquid electrophotographic printer comprising: a heating system configured to heat a coating composition comprising a thermoplastic polymer and a liquid carrier to dissolve the thermoplastic polymer in the liquid carrier and form a heated coating solution; and a coating applicator configured to apply the heated coating solution to a liquid electrophotographically printed substrate.

In some examples, the liquid electrophotographic printer may comprise: a heating system configured to heat a coating composition comprising a thermoplastic polymer and a liquid carrier to dissolve the thermoplastic polymer in the liquid carrier and form a heated coating solution; and a coating applicator configured to apply the heated coating solution to a liquid electrophotographically printed substrate; wherein the coating composition comprises: a thermoplastic polymer selected from a copolymer of ethylene and an alk-1-ene and a copolymer of ethylene and 50 wt. % or less vinyl acetate; and a liquid carrier comprising a hydrocarbon, a silicone oil or a vegetable oil.

In some examples, the liquid electrophotographic printer may comprise: a heating system configured to heat a coating composition comprising a thermoplastic polymer and a liquid carrier to dissolve the thermoplastic polymer in the liquid carrier and form a heated coating solution; and a coating applicator configured to apply the heated coating solution to a liquid electrophotographically printed substrate; wherein the coating composition comprises a thermoplastic polymer with a melting point of 75° C. or less and a melt flow rate of 5 g/10 min or less.

In another aspect, there is provided printed substrate comprising: a substrate; a liquid electrophotographically printed layer; and a coating composition disposed on the liquid electrophotographically printed layer; wherein the coating composition comprises a thermoplastic polymer. In some examples, the thermoplastic polymer is selected from a copolymer of ethylene and a linear alpha olefin and a copolymer of ethylene and 50 wt. % or less vinyl acetate. In some examples, the thermoplastic polymer has a melting point of 75° C. or less and a melt flow rate of 5 g/10 min or less.

Both water-based and irradiation-cured coatings can be applied to LEP printed images to increase the durability of the printed images. However, many water-based coatings are difficult to dry, requiring costly drying equipment, while many irradiation-cured coatings are not suitable for use in, for example, food packaging.

The coating compositions and methods described herein have been found to avoid or at least mitigate at least one of these difficulties. It has been found that these compositions can be applied in an in-line coating process, reducing the steps involved to produce coated products. Moreover, both the LEP ink composition and the coating composition can contain the same carrier liquid, simplifying the monitoring and recycling of the carrier liquid in the printing system and ensuring no additional volatile organic compounds (VOCs) are emitted. Furthermore, the coating compositions described herein can be optically transparent and may not significantly alter the visual appearance of the printed images.

### Liquid Electrophotographic Printing Kit

Described herein is a liquid electrophotographic printing kit. The liquid electrophotographic printing kit comprises a liquid electrophotographic ink composition and a coating composition. In some examples, the coating composition comprises a thermoplastic polymer and a liquid carrier. In some examples, heating the coating composition dissolves the thermoplastic polymer in the liquid carrier, forming a heated coating solution.

In some examples, the thermoplastic polymer has a melting point of 90° C. or less. In some examples, the thermoplastic polymer has a melt flow rate of 5 g/10 min or less. In some examples, the thermoplastic polymer has a melting point of 90° C. or less and a melt flow rate of 5 g/10 min.

In some examples, the thermoplastic polymer is selected from a copolymer of ethylene and an alk-1-ene and a copolymer of ethylene and 50 wt. % or less vinyl acetate. In some examples, the liquid carrier comprises a hydrocarbon, a silicone oil or a vegetable oil.

### Coating Composition

In an aspect, there is provided a coating composition comprising a thermoplastic polymer and a liquid carrier. In some examples, the coating composition further comprises an additive, for example, an additive selected from a wax, a fluoropolymer and a combination thereof. In some examples, the coating composition comprises a thermoplastic polymer, a wax and a liquid carrier. In some examples, the coating composition comprises a thermoplastic polymer, a fluoropolymer and a liquid carrier. In some examples, the coating composition comprises a thermoplastic polymer, a wax, a fluoropolymer and a liquid carrier.

### Thermoplastic Polymer

The coating composition may comprise a thermoplastic polymer. The thermoplastic polymer may comprise or consist of a thermoplastic polymer with a melting point of 90° C. or less and/or a melt flow rate of 5 g/10 min. The thermoplastic polymer may be selected from a copolymer of ethylene and an alk-1-ene and a copolymer of ethylene and 50 wt. % or less vinyl acetate.

In some examples, the thermoplastic polymer may have a melting point of about 90° C. or less, for example, about 85° C. or less, about 80° C. or less, about 79° C. or less, about 78° C. or less, about 77° C. or less, about 76° C. or less, about 75° C. or less, about 74° C. or less, about 73° C. or less, about 72° C. or less, about 71° C. or less, about 70° C. or less, about 69° C. or less, about 68° C. or less. In some examples, the thermoplastic polymer may have a melting point of about 50° C. or more, for example, about 55° C. or more, about 60° C. or more, about 61° C. or more, about 62° C. or more, about 63° C. or more, about 64° C. or more, about 65° C. or more, about 66° C. or more, about 67° C. or more, about 68° C. or more, about 69° C. or more, about 70° C. or more, about 71° C. or more, about 72° C. or more, about 73° C. or more, about 74° C. or more, about 75° C. or more. In some examples, the thermoplastic polymer may have a melting point of from about 50° C. to about 90° C., for example, from about 55° C. to about 85° C., about 60° C. to about 80° C., about 65° C. to about 75° C.

In some examples, the thermoplastic polymer may have a melt flow rate of about 5 g/10 min or less, for example, about 4.5 g/10 min or less, about 4 g/10 min or less, about 3.5 g/10 min or less, about 3 g/10 min or less, about 2.5 g/10 min or less, about 2 g/10 min or less, about 1.5 g/10 min or less, about 0.5 g/10 min or less, or about 0.1 g/10 min or less. In some examples, the thermoplastic polymer may have a melt flow rate of about 0.1 g/10 min or more, for example, about 0.5 g/10 min or more, about 1 g/10 min or more, about 1.5 g/10 min or more, about 2 g/10 min or more, about 2.5 g/10 min or more, about 3 g/10 min or more, about 3.5 g/10 min or more, about 4 g/10 min or more, about 4.5 g/10 min or more, or about 5 g/min. In some examples, the thermoplastic polymer may have a melt flow rate of from about 0.1 g/10 min to about 5 g/10 min, for example, about 0.5 g/10 min to about 4.5 g/10 min, about 1 g/10 min to about 4 g/10 min, about 1.5 g/10 min to about 3.5 g/10 min, about 2 g/10 min to about 3 g/10 min, or about 2.5 g/10 min to about 5 g/10 min. In some examples, the melt flow rate may be measured per ASTM D1238 Standard Test Method for Melt Flow Rates of Thermoplastics by Extrusion Plastometer. In some examples, the melt flow rate is determined at 190° C. with a load of 2.16 kg.

In some examples, the thermoplastic polymer may have a high weight average molecular weight. In some examples, polymers with a high weight average molecular weight have a low melt flow rate while polymers with a low weight average molecular weight have high melt flow rates. A high weight average molecular weight may be a weight average molecular weight of about 5000 g/mol or more. In some examples, the weight average molecular weight may be from about 5000 g/mol to about 100,000 g/mol, for example, about 6000 g/mol to about 50,000 g/mol, about 7000 g/mol to about 25,000 g/mol, about 8000 g/mol to about 20,000 g/mol. The weight average molecular weight may be determined by ASTM D4001-13 Standard test method for determination of weight-average molecular weight of polymers by light scattering.

In some examples, the thermoplastic polymer may comprise or consist of a copolymer of ethylene and an alk-1-ene, a copolymer of ethylene and vinyl acetate, or a combination thereof. In some examples, the copolymer of ethylene and vinyl acetate comprises 50 wt. % or less vinyl acetate.

In some examples, the thermoplastic polymer is a copolymer of ethylene and an alk-1-ene. In some examples, the thermoplastic polymer is a copolymer of ethylene and vinyl acetate, wherein the vinyl acetate may be present in an amount of 50 wt. % or less by weight of the copolymer of ethylene and vinyl acetate.

In some examples, the copolymer of ethylene and an alk-1-ene is a polyolefin plastomer. In some examples, a polyolefin plastomer is a random copolymer of ethylene and an alk-1-ene, for example, a linear alk-1-ene.

In some examples, the copolymer of ethylene and an alk-1-ene is a copolymer of ethylene and an alk-1-ene, wherein the alk-1-ene is not ethylene. In some examples, the copolymer of ethylene and an alk-1-ene is a copolymer of ethylene and a linear alk-1-ene. In some examples, the copolymer of ethylene and an alk-1-ene is a copolymer of ethylene and an alk-1-ene containing 3 or more carbon atoms, for example, 4 or more carbon atoms, 5 or more carbon atoms, 6 or more carbon atoms, 7 or more carbon atoms, 8 or more carbon atoms, 9 or more carbon atoms, 10 or more carbon atoms. In some examples, the copolymer of ethylene and an alk-1-ene is a copolymer of ethylene and an alk-1-ene containing up to 20 carbon atoms, for example, up to 15 carbon atoms, up to 10 carbon atoms, up to 9 carbon atoms, up to 8 carbon atoms, up to 7 carbon atoms, up to 6 carbon atoms, up to 5 carbon atoms, up to 4 carbon atoms, or 3 carbon atoms. In some examples, the thermoplastic polymer may be a copolymer of ethylene and an alk-1-ene containing 3 to 20 carbon atoms, for example, 4 to 15 carbon atoms, for example, 5 to 10 carbon atoms, 6 to 9 carbon atoms, or 7 to 8 carbon atoms.

In some examples, the thermoplastic polymer may be a copolymer of ethylene and a monomer selected from prop-1-ene, but-1-ene, pent-1-ene, hex-1-ene, hept-1-ene, oct-1-ene, non-1-ene, dec-1-ene, or a combination thereof. In some examples, the thermoplastic polymer may be a copolymer of ethylene and oct-1-ene.

In some examples, the copolymer of ethylene and an alk-1-ene may comprise at least about 65 wt. % ethylene, for example, at least about 70 wt. % ethylene, at least about 75 wt. % ethylene, at least about 80 wt. % ethylene, at least about 85 wt. % ethylene, at least about 90 wt. % ethylene, or about 91 wt. % ethylene. In some examples, the copolymer of ethylene and an alk-1-ene may comprise up to about 91 wt. % ethylene, for example, up to about 90 wt. % ethylene, up to about 85 wt. % ethylene, up to about 80 wt. % ethylene, up to about 75 wt. % ethylene, up to about 70 wt. % ethylene, up to about 65 wt. % ethylene, up to about 60 wt. % ethylene. In some examples, the copolymer of ethylene and an alk-1-ene may comprise from about 65 wt. % to about 91 wt. % ethylene, for example, from about 70 wt. % to about 90 wt. % ethylene, about 75 wt. % to about 85 wt. % ethylene, about 80 wt. % to about 91 wt. % ethylene. In some examples, the alk-1-ene constitutes the remaining weight of the copolymer.

In some examples, the copolymer of ethylene and an alk-1-ene (e.g., a linear alk-1-ene) may comprise at least about 9 wt. % alk-1-ene, for example, at least about 10 wt. % alk-1-ene, at least about 15 wt. % alk-1-ene, at least about 20 wt. % alk-1-ene, at least about 25 wt. % alk-1-ene, at least about 30 wt. % alk-1-ene, or at least about 35 wt. % alk-1-ene. In some examples, the copolymer of ethylene and an alk-1-ene (e.g., a linear alk-1-ene) may comprise up to about 35 wt. % alk-1-ene, for example, up to about 30 wt. % alk-1-ene, up to about 25 wt. % alk-1-ene, up to about 20 wt. % alk-1-ene, up to about 15 wt. % alk-1-ene, up to about 10 wt. % alk-1-ene or up to about 9 wt. % alk-1-ene. In some examples, the copolymer of ethylene and an alk-1-ene (e.g., a linear alk-1-ene) comprises from about 9 wt. % to about 35 wt. % alk-1-ene, for example, about 10 wt. % to about 30 wt. % alk-1-ene, about 15 wt. % to about 25 wt. % alk-1-ene, or about 9 wt. % to about 20 wt. % alk-1-ene. In some examples, ethylene constitutes the remaining weight of the copolymer.

In some examples, the copolymer of ethylene and an alk-1-ene is a polyolefin plastomer. A polyolefin plastomer may comprise at least 10 wt. % alk-1-ene.

In some examples, the thermoplastic polymer comprises a copolymer of ethylene and vinyl acetate. In some examples, the thermoplastic polymer comprises a copolymer of ethylene and up to 50 wt. % vinyl acetate. In some examples, the copolymer of ethylene and vinyl acetate comprises up to about 50 wt. % vinyl acetate, for example, up to about 45 wt. % vinyl acetate, up to about 40 wt. % vinyl acetate, up to about 35 wt. % vinyl acetate, up to about 30 wt. % vinyl acetate, up to about 28 wt. % vinyl acetate, up to about 25 wt. % vinyl acetate, up to about 20 wt. % vinyl acetate, up to about 18 wt. % vinyl acetate. In some examples, the copolymer of ethylene and vinyl acetate comprises at least about 10 wt. % vinyl acetate, for example, at least about 15 wt. % vinyl acetate, at least about 20 wt. % vinyl acetate, at least about 25 wt. % vinyl acetate, at least about 28 wt. % vinyl acetate, at least about 30 wt. % vinyl acetate, at least about 35 wt. % vinyl acetate, at least about 40 wt. % vinyl acetate, at least about 45 wt. % vinyl acetate, or at least about 50 wt. % vinyl acetate. In some examples, the copolymer of ethylene and vinyl acetate comprise from about 10 wt. % to about 50 wt. % vinyl acetate, for example, from about 15 wt. % to about 45 wt. % vinyl acetate, about 18 wt. % to about 40 wt. % vinyl acetate, about 20 wt. % to about 35 wt. % vinyl acetate, about 25 wt. % to about 30 wt. % vinyl acetate, about 25 wt. % to about 28 wt. % vinyl acetate. In some examples, the copolymer of ethylene and vinyl acetate comprises from about 18 wt. % to about 40 wt. % vinyl acetate. In some examples, ethylene constitutes the remaining weight of the copolymer.

In some examples, the coating composition comprises at least about 1 wt. % thermoplastic polymer, for example, at least about 2 wt. %, at least about 3 wt. %, at least about 4 wt. %, at least about 5 wt. %, at least about 6 wt. %, at least about 7 wt. %, at least about 8 wt. %, at least about 9 wt. %, or at least about 10 wt. % thermoplastic polymer. In some examples, the coating composition comprises up to about 10 wt. % thermoplastic polymer, for example, up to about 9 wt. %, up to about 8 wt. %, up to about 7 wt. %, up to about 6 wt. %, up to about 5 wt. %, up to about 4 wt. %, up to about 3 wt. %, up to about 2 wt. % or up to about 1 wt. % thermoplastic polymer. In some examples, the coating composition comprises from about 1 wt. % to about 10 wt. % thermoplastic polymer, for example, about 2 wt. % to about 9 wt. %, about 3 wt. % to about 8 wt. %, about 4 wt. % to about 7 wt. %, about 5 wt. % to about 6 wt. % thermoplastic polymer.

### Liquid Carrier

In some examples, the liquid carrier comprises a hydrocarbon, a silicone oil or a vegetable oil. In some examples, the liquid carrier comprises a hydrocarbon. In some examples, the liquid carrier of the coating composition is the same as or different from the liquid carrier of the liquid electrophotographic ink composition. In some examples, the liquid carrier of the coating composition is the same as the liquid carrier of the liquid electrophotographic ink composition.

During heating and application, the coating composition comprises a liquid carrier. Generally, the liquid carrier can act as a dispersing medium for the other components in the coating composition. When heated, the thermoplastic polymer dissolves in the liquid carrier, forming the heated coating solution. The liquid carrier can comprise or be a hydrocarbon, silicone oil, vegetable oil, and so forth. In some examples, the liquid carrier comprises or consists of a hydrocarbon.

The liquid carrier can include, but is not limited to, an insulating, non-polar, non-aqueous liquid that can be used as a medium for the thermoplastic polymer. The liquid carrier can include compounds that have a resistivity in excess of about 10⁹ ohm-cm. The liquid carrier may have a dielectric constant below about 5, in some examples below about 3. The carrier liquid can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the carrier liquids include, but are not limited to, aliphatic hydrocarbons, isoparaffinic compounds, paraffinic compounds, dearomatized hydrocarbon compounds, and the like.

In some examples, the carrier liquid may be a hydrocarbon. In some examples, the carrier liquid may be a branched chain hydrocarbon. In some examples, the branched chain hydrocarbon may comprise 5 to 15 carbon atoms, for example, 10 to 15 carbon atoms, or 11 to 12 carbon atoms. In some examples, the carrier liquid may be selected from liquids comprising a mixture of branched chain hydrocarbons having 5 to 15 carbon atoms, for example, 10 to 15 carbon atoms or 11 to 12 carbon atoms.

In particular, the liquid carriers can include, but are not limited to, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

Before heating the coating composition and/or before applying the heated coating solution to a liquid electrophotographically printed layer disposed on a substrate, the carrier liquid can constitute about 80% to about 99% by weight of the coating composition and/or the heated coating solution, in some examples 90% to 95% by weight of the coating composition and/or the heated coating solution. Before heating the coating composition, the carrier liquid may constitute about 80% to about 99% by weight of the coating composition, for example, about 90% to 95% by weight of the coating composition. Before applying the heated coating solution to a liquid electrophotographically printed layer disposed on a substrate, the liquid carrier may constitute about 80% to 99% by weight of the heated coating solution, in some examples 90% to 95% by weight of the heated coating solution.

The coating composition (which may be referred to herein as an overprint varnish layer, a varnish layer or a coating layer), once applied to the liquid electrostatically printed layer disposed on the substrate, may be substantially free from liquid carrier. In the application process and/or afterwards, the liquid carrier may be removed, for example, by an electrophoresis process during application and/or evaporation, such that substantially just solids are transferred to the substrate. Substantially free from liquid carrier may indicate that the coating layer contains less than 5 wt. % liquid carrier, in some examples, less than 2 wt. % liquid carrier, in some examples less than 1 wt. % liquid carrier, in some examples less than 0.5 wt. % liquid carrier. In some examples, liquid electrostatically printed ink is free from liquid carrier.

### Wax

In some examples, the coating composition further comprises a wax. In some examples, the wax may be a surface-active wax. In some examples, the wax may be a low melting point wax. In some examples, the addition of a wax to the coating composition may further improve the durability of the ink composition. Without wishing to be bound by theory, it is believed that the wax may increase the slip level of the surface.

A low melting point wax may have a melting point range of from about 60° C. to about 66° C., for example, from about 61° C. to about 65° C., about 62° C. to about 64° C. or about 61° C. to about 63° C.

In particular, the wax may include, but is not limited to Incromold K-BE-(HU), CRODAMIDE™ VRX-PW-(HU), or CRODAMIDE™ O-PA-(GD) (supplied by Croda).

In some examples, the coating composition may comprise up to about 5 wt. % wax, for example, up to about 4.5 wt. %, up to about 4 wt. %, up to 3.5 about wt. %, up to about 3 wt. %, or up to about 2.5 wt. % wax. In some examples, the coating composition may comprise at least about 0.5 wt. % wax, for example, at least about 1 wt. %, at least about 1.5 wt. %, at least about 2 wt. %, or at least about 2.5 wt. % wax. In some examples, the coating composition may comprise about 0.5 wt. % to about 5 wt. % wax, for example, about 1 wt. % to about 4.5 wt. %, about 1.5 wt. % to about 4 wt. %, about 2 wt. % to about 3.5 wt. % or about 2.5 wt. % to about 3 wt. % wax.

### Fluoropolymer

In some examples, the coating composition may further comprise a fluoropolymer. In some examples, the fluoropolymer may be polytetrafluoroethylene, a copolymer of fluoroethylene and a vinyl ether (for example a perfluorovinyl ether) a copolymer of ethylene and a fluoropolymer, polyvinylidene fluoride (PDVF), polyvinyl fluoride, or a combination thereof. In some examples, the addition of a fluoropolymer to the coating composition reduces the gloss of the coated substrate, providing a more matte looking coating that may have an appearance similar to the uncoated liquid electrophotographically printed layer.

In some examples, the fluoropolymer may include, but is not limited to, Lumiflon™ (available from AGC Chemicals), Synfluo™ 180 (available from MicroPowder™) Fluon™ (available from DuPont™), Kynar™ (available from Arkema™), Dyneon™ (available from 3M™).

In some examples, the coating composition may comprise from about 0.5 wt. % to about 5 wt. % fluoropolymer, for example, about 1 wt. % to about 4.5 wt. %, about 2 wt. % to about 4 wt. %, or about 3 wt. % to about 4.5 wt. %.

### Liquid Electrophotographic Ink Composition

In an aspect, there is provided a liquid electrophotographic (LEP) ink composition. The liquid electrophotographic ink composition may comprise a thermoplastic resin and a liquid carrier. In some examples, the liquid electrophotographic ink composition comprises a liquid carrier and chargeable particles comprising a thermoplastic resin.

In some examples, the liquid electrophotographic ink composition further comprises a colorant. In some examples, the LEP ink composition comprises a thermoplastic resin, a colorant and a liquid carrier.

In some examples, the LEP ink composition further comprises a charge adjuvant. In some examples, the LEP ink composition comprises a thermoplastic resin, a charge adjuvant and a liquid carrier. In some examples, the LEP ink composition comprises a thermoplastic resin, a colorant, a charge adjuvant and a liquid carrier.

In some examples, the LEP ink composition further comprises a charge director. In some examples, the LEP ink composition comprises a thermoplastic resin, a charge director and a liquid carrier. In some examples, the LEP ink composition comprises a thermoplastic resin, a colorant, a charge director and a liquid carrier. In some examples, the LEP ink composition comprises a thermoplastic resin, a charge adjuvant, a charge director and a liquid carrier. In some examples, the LEP ink composition comprises a thermoplastic resin, a colorant, a charge adjuvant, a charge director and a liquid carrier.

In some examples, the liquid electrophotographic ink composition comprises a thermoplastic resin comprises a copolymer of an alkylene monomer and a monomer selected from acrylic acid and methacrylic acid; and a liquid carrier comprising a hydrocarbon, a silicone oil or a vegetable oil; and wherein the liquid carrier of the coating composition and the liquid carrier of the liquid electrophotographic ink composition are the same.

### Thermoplastic Resin

In some examples, the thermoplastic resin may comprise a thermoplastic polymer. The thermoplastic resin may be referred to herein as a resin. In some examples, the thermoplastic resin may comprise a polymer selected from ethylene acrylic acid copolymers; ethylene methacrylic acid copolymers; ethylene vinyl acetate copolymers; copolymers of ethylene (e.g. 80 wt. % to 99.9 wt. %), and alkyl (e.g. C1 to C5) ester of methacrylic or acrylic acid (e.g. 0.1 wt. % to 20 wt. %); copolymers of ethylene (e.g. 80 wt. % to 99.9 wt. %), acrylic or methacrylic acid (e.g. 0.1 wt. % to 20 wt. %) and alkyl (e.g. C1 to C5) ester of methacrylic or acrylic acid (e.g. 0.1 wt. % to 20 wt. %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is, in some examples, from 1 to about 20 carbon atoms, such as methyl methacrylate (e.g. 50 wt. % to 90 wt. %)/methacrylic acid (e.g. 0 wt. % to 20 wt. %)/ethylhexylacrylate (e.g. 10 wt. % to 50 wt. %)); ethylene-acrylate terpolymers: ethylene-acrylic esters-maleic anhydride (MAH) or glycidyl methacrylate (GMA) terpolymers; ethylene-acrylic acid ionomers and combinations thereof.

The thermoplastic resin may comprise a polymer having acidic side groups. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g, can be measured using standard procedures known in the art, for example, using the procedure described in ASTM D1386.

The thermoplastic resin may comprise a polymer having acidic side groups that has a melt flow rate of less than about 60 g/10 minutes, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of in some examples about 50 g/10 minutes to about 120 g/10 minutes, in some examples 60 g/10 minutes to about 100 g/10 minutes. The melt flow rate can be measured using standard procedures known in the art, for example, as described in ASTM D1238.

The thermoplastic resin may comprise a copolymer of an alkylene monomer and a monomer having acidic side groups. In some examples, the alkylene monomer may be selected from ethylene and propylene. In some examples, the monomer having acidic side groups may be selected from methacrylic acid and acrylic acid. In some examples, the thermoplastic resin may comprise a copolymer of an alkylene monomer and a monomer selected from methacrylic acid and acrylic acid. In some examples, the thermoplastic resin may comprise a copolymer of ethylene and a monomer selected from methacrylic acid and acrylic acid.

In some examples, the polymer having acidic side groups is a copolymer of an alkylene monomer and a monomer selected from acrylic acid and methacrylic acid. In some examples, the thermoplastic resin may comprise a copolymer of an alkylene monomer and a monomer selected from acrylic acid and methacrylic acid.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic side groups can be selected from resins such as copolymers of ethylene and an ethylenically unsaturated acid of either acrylic acid or methacrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The polymer comprising acidic side groups can be a copolymer of ethylene and an ethylenically unsaturated acid of either acrylic or methacrylic acid, where the ethylenically unsaturated acid of either acrylic or methacrylic acid constitute from 5 wt. % to about 25 wt. % of the copolymer, in some examples from 10 wt. % to about 20 wt. % of the copolymer.

The thermoplastic resin may comprise two different polymers having acidic side groups. The two polymers having acidic side groups may have different acidities, which may fall within the ranges mentioned above. The thermoplastic resin may comprise a first polymer having acidic side groups that has an acidity of from 50 mg KOH/g to 110 mg KOH/g and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The resin may comprise a copolymer of ethylene and acrylic acid and a copolymer of ethylene and methacrylic acid.

The resin may comprise two different polymers having acidic side groups: a first polymer that is a copolymer of ethylene (e.g. 92 to 85 wt. %, in some examples about 89 wt. %) and acrylic or methacrylic acid (e.g. 8 to 15 wt. %, in some examples about 11 wt. %) having a melt flow rate of 80 to 110 g/10 minutes and a second polymer that is a copolymer of ethylene (e.g. about 80 to 92 wt. %, in some examples about 85 wt. %) and acrylic acid (e.g. about 18 to 12 wt. %, in some examples about 15 wt. %), having a melt viscosity lower than that of the first polymer, the second polymer for example having a melt viscosity of 15000 poise or less, in some examples a melt viscosity of 10000 poise or less, in some examples 1000 poise or less, in some examples 100 poise or less, in some examples 50 poise or less, in some examples 10 poise or less. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

In any of the resins mentioned above, the ratio of the first polymer having acidic side groups to the second polymer having acidic side groups can be from about 10:1 to about 2:1. In another example, the ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), an example of the second polymer is Nucrel 699 (from DuPont), and an example of the third polymer is AC-5120 (from Honeywell). In some examples, the resin may comprise a first polymer having a melt viscosity of from 15000 poise to 40000 poise, in some examples 20000 poise to 30000 poise, and a second polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 699 (from DuPont), and an example of the second polymer is AC-5120 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

If the resin comprises a single type of resin polymer, the resin polymer (excluding any other components of the electrostatic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

The resin may comprise two different polymers having acidic side groups that are selected from copolymers of ethylene and an ethylenically unsaturated acid of either methacrylic acid or acrylic acid; and ionomers thereof, such as methacrylic acid and ethylene-acrylic or methacrylic acid copolymers which are at least partially neutralized with metal ions (e.g. Zn, Na, Li) such as SURLYN® ionomers.

The resin may comprise (i) a first polymer that is a copolymer of ethylene and an ethylenically unsaturated acid of either acrylic acid and methacrylic acid, wherein the ethylenically unsaturated acid of either acrylic or methacrylic acid constitutes from 8 wt. % to about 16 wt. % of the copolymer, in some examples 10 wt. % to 16 wt. % of the copolymer; and (ii) a second polymer that is a copolymer of ethylene and an ethylenically unsaturated acid of either acrylic acid and methacrylic acid, wherein the ethylenically unsaturated acid of either acrylic or methacrylic acid constitutes from 12 wt. % to about 30 wt. % of the copolymer, in some examples from 14 wt. % to about 20 wt. % of the copolymer, in some examples from 16 wt. % to about 20 wt. % of the copolymer in some examples from 17 wt. % to 19 wt. % of the copolymer.

In an example, the resin constitutes about 5 to 90%, in some examples about 5 to 80% by weight of the total solids of the electrostatic ink composition. In another example, the resin constitutes about 10 to 60% by weight of the total solids of the electrostatic ink composition. In another example, the resin constitutes about 15 to 40% by weight of the total solids of the electrostatic ink composition. In another example, the resin constitutes about 60 to 95% by weight, in some examples, from 65 to 90% by weight, from 65 to 80% by weight of the total solids of the electrostatic ink composition.

The resin may comprise a polymer having acidic side groups, as described above (which may be free of ester side groups), and a polymer having ester side groups. The polymer having ester side groups is, in some examples, a thermoplastic polymer. The polymer having ester side groups may further comprise acidic side groups. The polymer having ester side groups may be a copolymer of a monomer having ester side groups and a monomer having acidic side groups. The polymer may be a copolymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a copolymer of a first monomer having ester side groups, a second monomer having acidic side groups and a third monomer which is an alkylene monomer absent of any acidic and ester side groups. The polymer having ester side groups may be a copolymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1 to 50% by weight of the copolymer, in some examples 5 to 40% by weight, in some examples 5 to 20% by weight of the copolymer, in some examples 5 to 15% by weight of the copolymer. The second monomer may constitute 1 to 50% by weight of the copolymer, in some examples 5 to 40% by weight of the copolymer, in some examples 5 to 20% by weight of the copolymer, in some examples 5 to 15% by weight of the copolymer. In an example, the first monomer constitutes 5 to 40% by weight of the copolymer, the second monomer constitutes 5 to 40% by weight of the copolymer, and with the third monomer constituting the remaining weight of the copolymer. In an example, the first monomer constitutes 5 to 15% by weight of the copolymer, the second monomer constitutes 5 to 15% by weight of the copolymer, with the third monomer constituting the remaining weight of the copolymer. In an example, the first monomer constitutes 8 to 12% by weight of the copolymer, the second monomer constitutes 8 to 12% by weight of the copolymer, with the third monomer constituting the remaining weight of the copolymer. In an example, the first monomer constitutes about 10% by weight of the copolymer, the second monomer constitutes about 10% by weight of the copolymer, and with the third monomer constituting the remaining weight of the copolymer. The polymer having ester side groups may be selected from the Bynel® class of monomer, including Bynel 2022 and Bynel 2002, which are available from DuPont®.

The polymer having ester side groups may constitute 1% or more by weight of the total amount of the resin polymers in the resin, e.g. the total amount of the polymer or polymers having acidic side groups and polymer having ester side groups. The polymer having ester side groups may constitute 5% or more by weight of the total amount of the resin polymers in the resin, in some examples 8% or more by weight of the total amount of the resin polymers in the resin, in some examples 10% or more by weight of the total amount of the resin polymers in the resin, in some examples 15% or more by weight of the total amount of the resin polymers in the resin, in some examples 20% or more by weight of the total amount of the resin polymers in the resin, in some examples 25% or more by weight of the total amount of the resin polymers in the resin, in some examples 30% or more by weight of the total amount of the resin polymers in the resin, in some examples 35% or more by weight of the total amount of the resin polymers in the resin. The polymer having ester side groups may constitute from 5% to 50% by weight of the total amount of the resin polymers in the resin, in some examples 10% to 40% by weight of the total amount of the resin polymers in the resin, in some examples 15% to 30% by weight of the total amount of the polymers in the resin.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

In an example, the polymer or polymers of the resin can be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™ Nucrel 910™, Nucrel 925™, Nucrel 699™, Nucrel 599™, Nucrel 960™, Nucrel RX 76™, Nucrel 2806™, Bynell 2002, Bynell 2014, and Bynell 2020 (sold by E. I. du PONT)), the Aclyn family of toners (e.g. Aclyn 201, Aclyn 246, Aclyn 285, and Aclyn 295), AC-5120 and AC 580 (sold by Honeywell), and the Lotader family of toners (e.g. Lotader 2210, Lotader, 3430, and Lotader 8200 (sold by Arkema)).

In some examples, the resin may constitute 5% to 99% by weight of the total solids in the LEP ink composition, in some examples 50% to 90% by weight of the total solids of the LEP ink composition, in some examples 65% to 80% by weight of the total solids of the LEP ink composition. In some examples, the LEP ink composition may comprise resin in an amount of from 10% to 50% by weight of the total solids, for example, 15% to 45% by weight, 20% to 40% by weight, 25% to 35% by weight of the total solids.

### Liquid Carrier

In some examples, when printing, the liquid electrophotographic ink composition comprises a carrier liquid. Generally, the carrier liquid can act as a dispersing medium for the other components in the liquid electrophotographic ink composition. For example, the carrier liquid can comprise or be a hydrocarbon, silicone oil, vegetable oil, and so forth. In some examples, the liquid carrier of the LEP ink composition may be the same as the liquid carrier of the coating composition.

The carrier liquid can include, but is not limited to, an insulating, non-polar, non-aqueous liquid that can be used as a medium for toner particles. The carrier liquid can include compounds that have a resistivity in excess of about 10⁹ ohm-cm. The carrier liquid may have a dielectric constant below about 5, in some examples below about 3. The carrier liquid can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the carrier liquids include, but are not limited to, aliphatic hydrocarbons, isoparaffinic compounds, paraffinic compounds, dearomatized hydrocarbon compounds, and the like.

In some examples, the carrier liquid may be a hydrocarbon. In some examples, the carrier liquid may be a branched chain hydrocarbon. In some examples, the branched chain hydrocarbon may comprise 5 to 15 carbon atoms, for example, 10 to 15 carbon atoms, or 11 to 12 carbon atoms. In some examples, the carrier liquid may be selected from liquids comprising a mixture of branched chain hydrocarbons having 5 to 15 carbon atoms, for example, 10 to 15 carbon atoms or 11 to 12 carbon atoms.

In particular, the liquid carriers can include, but are not limited to, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

Before liquid electrophotographic printing, the carrier liquid can constitute about 20% to 99.5% by weight of the liquid electrostatic ink composition, in some examples 50% to 99.5% by weight of the liquid electrostatic ink composition. Before printing, the carrier liquid may constitute about 40% to 90% by weight of the liquid electrostatic ink composition. Before printing, the carrier liquid may constitute about 60% to 80% by weight of the liquid electrostatic ink composition. Before printing, the liquid carrier may constitute about 90% to 99.5% by weight of the liquid electrostatic ink composition, in some examples 95% to 99% by weight of the liquid electrostatic ink composition.

The liquid electrostatic ink composition, once electrostatically printed on the substrate, may be substantially free from liquid carrier. In an electrostatic printing process and/or afterwards, the liquid carrier may be removed, for example, by an electrophoresis processes during printing and/or evaporation, such that substantially just solids are transferred to the substrate. Substantially free from liquid carrier may indicate that liquid electrostatically printed ink contains less than 5 wt. % liquid carrier, in some examples, less than 2 wt. % liquid carrier, in some examples less than 1 wt. % liquid carrier, in some examples less than 0.5 wt. % liquid carrier. In some examples, liquid electrostatically printed ink is free from liquid carrier.

### Colorant

The liquid electrophotographic ink composition may include a colorant or a pigment. In some examples, the chargeable particles comprise a colorant or a pigment.

As used herein, “pigment” generally includes pigment colorants, magnetic particles, aluminas, silicas, and/or other ceramics or organometallics. Thus, though the present description primarily exemplifies the use of pigment colorants, the term “pigment” can be used more generally to describe not only pigment colorants, but also other pigments such as organometallics, ferrites, ceramics, and so forth. The pigments may include pigments that impart colours, such as black, magenta, cyan, yellow and white, to an ink. In some examples, the pigment may be a single pigment or a mixture of two or more pigments.

In some examples, the colorant is selected from cyan pigments, magenta pigments, yellow pigments, black pigments, white pigments and silver pigments. In some examples, the pigment is selected from cyan pigments, magenta pigments, yellow pigments, black pigments or white pigments. In some examples, the pigment may be selected from cyan pigments, yellow pigments or black pigments. In some examples, the pigment may be selected from cyan pigments.

The pigment can be any pigment compatible with the carrier liquid and useful for liquid electrophotographic printing. For example, the pigment may be present as pigment particles, or may comprise a resin as described herein and a pigment. The pigments can be any of those standardly used in the art. In some examples, the pigment is selected from a cyan pigment, a magenta pigment, a yellow pigment and a black pigment. For example, pigments by Clariant including Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM® YELLOW HR, NOVAPERM® YELLOW FGL, Hansa Brilliant Yellow 10GX, Permanent Yellow G3R-01, HOSTAPERM® YELLOW H4G, HOSTAPERM® YELLOW H3G, HOSTAPERM® ORANGE GR, HOSTAPERM® SCARLET GO, Permanent Rubine F6B; pigments by Sun Chemical including L74-1357 Yellow, L75-1331 Yellow, L75-2337 Yellow; pigments by Heubach including DALAMAR® YELLOW YT-858-D; pigments by Ciba-Geigy including CROMOPHTHAL® YELLOW 3 G, CROMOPHTHAL® YELLOW GR, CROMOPHTHAL® YELLOW 8 G, IRGAZINE® YELLOW 5GT, IRGALITE® RUBINE 4BL, MONASTRAL® MAGENTA, MONASTRAL® SCARLET, MONASTRAL® VIOLET, MONASTRAL® RED, MONASTRAL® VIOLET; pigments by BASF including LUMOGEN® LIGHT YELLOW, PALIOGEN® ORANGE, HELIOGEN® BLUE L 690 IF, HELIOGEN® BLUE TBD 7010, HELIOGEN® BLUE K 7090, HELIOGEN® BLUE L 710 IF, HELIOGEN® BLUE L 6470, HELIOGEN® GREEN K 8683, HELIOGEN® GREEN L 9140; pigments by Mobay including QUINDO® MAGENTA, INDOFAST® BRILLIANT SCARLET, QUINDO® RED 6700, QUINDO® RED 6713, INDOFAST® VIOLET; pigments by Cabot including Maroon B STERLING® NS BLACK, STERLING® NSX 76, MOGUL® L; pigments by DuPont including TIPURE® R-101; and pigments by Paul Uhlich including UHLICH® BK 8200. If the pigment is a white pigment particle, the pigment particle may be selected from the group consisting of TiO₂, calcium carbonate, zinc oxide, and mixtures thereof. In some examples, the white pigment particle may comprise an alumina-TiO₂ pigment. If the pigment is a silver pigment, the pigment may be an aluminium powder. If the pigment is a cyan pigment, it may be a copper phthalocyanine pigment.

The pigment may be present in the liquid electrophotographic ink composition in an amount of from 10 wt. % to 80 wt. % of the total amount of resin and pigment, in some examples, 15 wt. % to 80 wt. %, in some examples, 15 wt. % to 60 wt. %, in some examples, 15 wt. % to 50 wt. %, in some examples, 15 wt. % to 40 wt. %, in some examples, 15 wt. % to 30 wt. %, in some examples, 10 wt. % to 25 wt. %, in some examples, 15 wt. % to 20 wt. % of the total amount of resin and pigments. In some examples, the pigment particle may be present in an electrostatic ink composition in an amount of at least 50 wt. % of the total amount of resin and pigment, for example, at least 55 wt. % of the total amount of resin and pigment.

### Charge Director

In some examples, the LEP ink composition further includes a charge director. The charge director may be added in order to impart and/or maintain sufficient electrostatic charge on the ink particles, which may be particles comprising the thermoplastic resin.

In some examples, the charge director may comprise ionic compounds, particularly metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g. neutral Calcium Petronate™, neutral Barium Petronate™, and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminum salts of sulfonic acid. The sulfonic acids may include, but are not limited to, alkyl sulfonic acids, aryl sulfonic acids, and sulfonic acids of alkyl succinates. The charge director can impart a negative charge or a positive charge on the resin-containing particles of a LEP ink composition.

In some examples, the liquid electrostatic ink composition comprises a charge director comprising a simple salt. The ions constructing the simple salts are all hydrophilic. The simple salt may include a cation selected from the group consisting of Mg, Ca, Ba, NH₄, tert-butyl ammonium, Li⁺, and Al³⁺, or from any sub-group thereof. The simple salt may include an anion selected from the group consisting of SO₄²⁻, PO₃⁻, NO₃⁻, HPO₄²⁻, CO₃²⁻, acetate, trifluoroacetate (TFA), Cl⁻, BF₄⁻, F⁻, ClO₄⁻, and TiO₃⁴⁻ or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, tert-butyl ammonium bromide, NH₄NO₃, LiTFA, Al₂(SO₄)₃, LiClO₄ and LiBF₄, or any sub-group thereof.

In some examples, the electrostatic ink composition comprises a charge director comprising a sulfosuccinate salt of the general formula MAₙ, wherein M is a metal, n is the valence of M, and A is an ion of the general formula (I): [R¹—O—C(O)CH₂CH(SO₃—)—C(O)—O—R²], wherein each of R¹ and R² is an alkyl group. In some examples each of R¹ and R² is an aliphatic alkyl group. In some examples, each of R¹ and R² independently is a C6-25 alkyl. In some examples, said aliphatic alkyl group is linear. In some examples, said aliphatic alkyl group is branched. In some examples, said aliphatic alkyl group includes a linear chain of more than 6 carbon atoms. In some examples, R¹ and R² are the same. In some examples, at least one of R¹ and R² is C₁₃H₂₇. In some examples, M is Na, K, Cs, Ca, or Ba.

In some examples, the charge director comprises at least one micelle forming salt and nanoparticles of a simple salt as described above. The simple salts are salts that do not form micelles by themselves, although they may form a core for micelles with a micelle forming salt. The sulfosuccinate salt of the general formula MA, is an example of a micelle forming salt. The charge director may be substantially free of an acid of the general formula HA, where A is as described above. The charge director may include micelles of said sulfosuccinate salt enclosing at least some of the nanoparticles of the simple salt. The charge director may include at least some nanoparticles of the simple salt having a size of 200 nm or less, and/or in some examples 2 nm or more.

The charge director may include one of, some of or all of (i) soya lecithin, (ii) a barium sulfonate salt, such as basic barium petronate (BBP), and (iii) an isopropyl amine sulfonate salt. Basic barium petronate is a barium sulfonate salt of a 21-26 carbon atom hydrocarbon alkyl, and can be obtained, for example, from Chemtura. An example isopropyl amine sulphonate salt is dodecyl benzene sulfonic acid isopropyl amine, which is available from Croda.

In some examples, the charge director constitutes about 0.001% to 20% by weight, in some examples 0.01% to 20% by weight, in some examples 0.01% to 10% by weight, in some examples 0.01% to 5% by weight of the total solids of a liquid electrostatic ink composition. In some examples, the charge director constitutes about 1% to 4% by weight of the total solids of the liquid electrostatic ink composition, in some examples 2% to 4% by weight of the total solids of the electrostatic ink composition.

In some examples, the charge director is present in an amount of from 3 mg/g to 50 mg/g, in some examples from 3 mg/g to 45 mg/g, in some examples from 10 mg/g to 40 mg/g, in some examples from 5 mg/g to 35 mg/g, in some examples, 20 mg/g to 35 mg/g, in some examples, 22 mg/g to 34 mg/g (where mg/g indicates mg per gram of solids of the liquid electrostatic ink composition).

### Charge Adjuvant

In some examples, the LEP ink composition further includes a charge adjuvant. A charge adjuvant may promote charging of the particles when a charge director is present. The method as described herein may involve adding a charge adjuvant at any stage. The charge adjuvant can include, for example, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), or hydroxy bis(3,5-di-tert-butyl salicylic) aluminate monohydrate. In an example, the charge adjuvant is or includes aluminum di- or tristearate. In some examples, the charge adjuvant is VCA (aluminium stearate and aluminium palmitate, available from Sigma Aldrich).

The charge adjuvant may be present in an amount of about 0.001% to 5% by weight, in some examples about 0.1% to 1% by weight, in some examples about 0.3% to 0.8% by weight of the total solids of the liquid electrostatic ink composition, in some examples, about 1 wt. % to 5 wt. % of the total solids of the liquid electrostatic ink, in some examples about 1 wt. % to 3 wt. % of the total solids of the liquid electrostatic ink composition, in some examples about 1.5 wt. % to 2.5 wt. % of the total solids of the liquid electrostatic ink composition.

The charge adjuvant may be present in an amount of less than 5% by weight of total solids of the liquid electrostatic ink composition, in some examples in an amount of less than 4.5% by weight, in some examples in an amount of less than 4% by weight, in some examples in an amount of less than 3.5% by weight, in some examples in an amount of less than 3% by weight, in some examples in an amount of less than 2.5% by weight, in some examples, in an amount of less than 2% by weight of the total solids of the liquid electrostatic ink composition.

In some examples, the liquid electrostatic ink composition further includes, e.g. as a charge adjuvant, a salt of multivalent cation and a fatty acid anion. The salt of multivalent cation and a fatty acid anion can act as a charge adjuvant. The multivalent cation may, in some examples, be a divalent or a trivalent cation. In some examples, the multivalent cation is selected from Group 2, transition metals and Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al³⁺. The fatty acid anion may be selected from a saturated or unsaturated fatty acid anion. The fatty acid anion may be selected from a C8 to C26 fatty acid anion, in some examples a C14 to C22 fatty acid anion, in some examples a C16 to C20 fatty acid anion, in some examples a C17, C18 or C19 fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

In some examples, the charge adjuvant comprises, consists essentially of or consists of an aluminium stearate (e.g., aluminium tristearate), aluminium palmitate and combinations thereof. In some examples, the charge adjuvant comprises, consists essentially of or consists of aluminium tristearate and aluminium palmitate.

The charge adjuvant, which may, for example, be or include a salt of a multivalent cation and a fatty acid anion, may be present in an amount of 0.1 wt. % to 5 wt. % of the total solids of the liquid electrostatic ink composition, in some examples in an amount of 0.1 wt. % to 3 wt. % of the total solids of the liquid electrostatic ink composition, in some examples about 1 wt. % to 3 wt. % of the total solids of the liquid electrostatic ink composition, in some examples about 1.5 wt. % to 2.5 wt. % of the total solids of the liquid electrostatic ink composition.

### Other Additives

The LEP ink composition may include another additive or a plurality of other additives. The other additive or plurality of other additives may be added at any stage of the method. The other additive or plurality may be selected from a wax, a surfactant, viscosity modifiers, and compatibility additives. The wax may be an incompatible wax. As used herein, “incompatible wax” may refer to a wax that is incompatible with the resin. Specifically, the wax phase separates from the resin phase upon cooling of the resin fused mixture on a print substrate during and after the transfer of the ink film to the print substrate, e.g., from an intermediate transfer member, which may be a heated blanked. In some examples, the LEP ink composition comprises silica, which may be added, for example, to improve the durability of images produced using the LEP ink. The other additives may constitute 10 wt. % or less of the total solids of the LEP ink composition, in some examples, 5 wt. % or less or 3 wt. % or less of the total solids of the LEP ink composition.

### Printed Substrate

In some examples, there is provided a printed substrate. The printed substrate may comprise a substrate; a liquid electrophotographically printed layer; and a coating layer (which may be referred to as an overprint varnish layer). The printed substrate may comprise a substrate, a coating layer and a liquid electrophotographically printed layer disposed between the coating layer and the substrate. In some examples, the printed substrate may comprise a substrate; a liquid electrophotographically printed layer disposed on the substrate; and a coating layer disposed on the liquid electrophotographically printed layer.

In some examples, the coating layer comprises a thermoplastic polymer, for example, any thermoplastic polymer described herein as forming part of the coating composition. In some examples, the coating layer is formed by applying the heated coating solution described herein (which may be formed by heating the coating composition described herein).

In some examples, the printed substrate comprises a substrate; a liquid electrophotographically printed layer; and a coating layer comprising a thermoplastic polymer selected from a copolymer of ethylene and an alk-1-ene (for example, a linear alk-1-ene) and a copolymer of ethylene and vinyl acetate (for example, 50 wt. % or less vinyl acetate).

### Substrate

In some examples, the substrate may be any suitable substrate. In some examples, the substrate may be any suitable substrate capable of having an image printed thereon. The substrate may include a material selected from an organic or inorganic material. The material may include a natural polymeric material, for example, cellulose. The material may include a synthetic polymeric material, for example, a polymer formed from alkylene monomers, including, but not limited to, polyethylene, polypropylene, and co-polymers such as styrene-polybutadiene. The polypropylene may, in some examples, be biaxially oriented polypropylene. The material may include a metal, which may be in sheet form. The metal may be selected from or made from, for instance, aluminium (Al), silver (Ag), tin (Sn), copper (Cu) and mixtures thereof. In an example, the substrate includes a cellulosic paper. In an example, the cellulosic paper is coated with a polymeric material, for example, a polymer formed from styrene-butadiene resin.

In some examples, the cellulosic material has an inorganic material bound to its surface (before printing with ink) with a polymeric material, wherein the inorganic material may be selected from, for example, kaolinite or calcium carbonate. In some examples, the substrate is a cellulosic substrate such as paper. In some examples, the cellulosic substrate may be a coated cellulosic substrate. In some examples, a primer may be coated onto the print substrate before the liquid electrophotographic ink composition is printed onto the substrate.

In some examples, the substrate may be a plastic film. In some examples, the substrate may be any plastic film capable of having an image printed thereon. The plastic film may include a synthetic polymeric material, for example, a polymer formed from alkylene monomers, including, for example, polyethylene and polypropylene, and co-polymers such as styrene-polybutadiene polymers. The polypropylene may, in some examples, be biaxially orientated polypropylene. In some examples, the plastic film may comprise polyethylene terephthalate.

In some examples, the plastic film is a thin film. In some examples, the plastic film comprises polyethylene (PE), linear low density polyethylene (LLDPE), low density polyethylene (LDPE), medium density polyethylene (MDPE), high density polyethylene (HDPE), polypropylene (PP), cast (cPP) or biaxially oriented polypropylene (BOPP), oriented polyamide (OPA), or polyethylene terephthalate (PET).

In some examples, the substrate comprises a plurality of layers of material laminated together to form a pre-laminated substrate. In some examples, the substrate comprises a plurality of layers of material laminated together to form a pre-laminated substrate in which a plastic film forms the surface onto which a liquid electrophotographic ink composition can be applied. In some examples, the substrate comprises a plurality of layers of film laminated together to form a pre-laminated substrate in which a plastic film forms the surface onto which a liquid electrophotographic ink composition can be applied. In an example, the substrate may be a plastic film laminated to, adhered to or coated on a cellulosic paper. In some examples, the substrate comprises a plurality of layers of material selected from polymeric materials (e.g. polymeric materials selected from PE, LLDPE, MDPE, PP, BOPP, PET and OPA), metallic materials (e.g. metallic foils such as aluminium foil, or metallized films such as met-PET, met-BOPP or any other metalized substrate), paper and combinations thereof. In some examples, the substrate comprises a plurality of layers of film of a plastic material, such as a combination of films selected from PE, LLDPE, MDPE, PP, BOPP, PET and OPA, laminated together to form the pre-laminated substrate. In some examples, the pre-laminated substrate comprises a Paper/Alu/PE, PET/AI/PE, BOPP/met-BOPP or PET/PE laminate.

### Liquid Electrophotographic Printing Process

In an aspect, there is provided a liquid electrophotographic printing process. The liquid electrophotographic printing process may comprise heating a coating composition comprising a thermoplastic polymer and a liquid carrier to dissolve the thermoplastic polymer in the liquid carrier and form a heated coating solution; applying the heated coating solution to a liquid electrophotographically printed layer disposed on a substrate. The coating composition may be any coating composition described herein.

In some examples, the coating composition may comprise a thermoplastic polymer with a melting point of 75° C. or less and/or a melt flow rate of 5 g/10 min or less. In some examples, the thermoplastic polymer is selected from a copolymer of ethylene and an alk-1-ene and a copolymer of ethylene and 50 wt. % or less vinyl acetate. In some examples, the liquid carrier comprises a hydrocarbon, a silicone oil or a vegetable oil.

The coating composition may be heated to dissolve the thermoplastic polymer in the liquid carrier and form a heated coating solution. The coating composition may be heated to a temperature at which the thermoplastic polymer is dissolved in the liquid carrier. In some examples, the coating composition is heated to a temperature of at least about 50° C. to dissolve the thermoplastic polymer in the liquid carrier, for example, to a temperature of at least about 51° C., at least about 52° C., at least about 53° C., at least about 54° C., at least about 55° C., at least about 56° C., at least about 57° C., at least about 58° C., at least about 59° C., at least about 60° C., at least about 61° C., at least about 62° C., at least about 63° C., at least about 64° C., at least about 65° C., at least about 66° C., at least about 67° C., at least about 68° C., at least about 69° C., or at least about 70° C. to dissolve the thermoplastic polymer in the liquid carrier, forming the heated coating solution. In some examples, the coating composition is heated to a temperature of up to about 70° C. to dissolve the thermoplastic polymer in the liquid carrier, for example, to a temperature of up to about 69° C., up to about 68° C., up to about 67° C., up to about 66° C., up to about 65° C., up to about 64° C., up to about 63° C., up to about 62° C., up to about 61° C., up to about 60° C., up to about 59° C., up to about 58° C., up to about 57° C., up to about 56° C., up to about 55° C., up to about 54° C., up to about 53° C., up to about 52° C., up to about 51° C., or up to about 50° C. to dissolve the thermoplastic polymer in the liquid carrier, forming the heated coating solution. In some examples, the coating composition is heated to a temperature of from about 60° C. to about 70° C. to dissolve the thermoplastic polymer in the liquid carrier, forming the heated coating solution. In some examples, the coating composition is heated to a temperature of from about 50° C. to about 70° C. to dissolve the thermoplastic polymer in the liquid carrier, for example, about 51° C. to about 70° C., about 52° C. to about 69° C., about 53° C. to about 68° C., about 54° C. to about 67° C., about 55° C. to about 66° C., about 56° C. to about 65° C., about 57° C. to about 64° C., about 58° C. to about 63° C., about 59° C. to about 62° C., or about 60° C. to about 61° C. to form the heated coating solution (by dissolving the thermoplastic polymer in the liquid carrier).

The heated coating solution may comprise the coating composition in which the thermoplastic polymer is dissolved in the liquid carrier. The heated coating solution may be at a temperature at which the thermoplastic polymer is dissolved in the liquid carrier.

In some examples, the coating composition is heated to form the heated coating solution and then applied directly to the liquid electrophotographically printed layer disposed on a substrate. In some examples, the coating composition is heated to form the heated coating solution and the heated coating solution is maintained at a temperature at which the thermoplastic polymer remains dissolved in the liquid carrier until the heated coating solution is applied to the liquid electrophotographically printed layer disposed on the substrate.

In some examples, the coating composition is heated to a first temperature to dissolve the thermoplastic polymer in the liquid carrier and allowed to cool to a second temperature at which the thermoplastic polymer remains dissolved in the liquid carrier. The heated coating solution may then be maintained at the second temperature until it is applied to the liquid electrophotographically printed substrate. In some examples, the heated coating solution is maintained at the second temperature and applied to the liquid electrophotographically printed substrate at the second temperature.

In some examples, the liquid electrophotographic printing process comprises heating the coating composition to a first temperature to dissolve the thermoplastic polymer in the liquid carrier and form a heated coating solution; and applying the heated coating solution to a liquid electrophotographically printed layer disposed on the substrate at a second temperature.

In some examples, the second temperature is a temperature of at least about 50° C., for example, at least about 51° C., at least about 52° C., at least about 53° C., at least about 54° C., at least about 55° C., at least about 56° C., at least about 57° C., at least about 58° C., at least about 59° C., or at least about 60° C. In some examples, the second temperature is a temperature of up to about 60° C., for example, up to about 59° C., up to about 58° C., up to about 57° C., up to about 56° C., up to about 55° C., up to about 54° C., up to about 53° C., up to about 52° C., up to about 51° C., or up to about 50° C. In some examples, the second temperature is a temperature of from about 50° C. to about 60° C., for example, about 51° C. to about 60° C., about 52° C. to about 59° C., about 53° C. to about 58° C., about 54° C. to about 57° C., or about 55° C. to about 56° C.

In some examples, the liquid carrier is removed in the coating application process and/or afterwards. In some examples, the liquid carrier may be removed by, for example, evaporation, air-flow-assisted drying, IR heating, vacuum or electrophoresis.

In some examples, the liquid electrophotographic printing process comprises heating a coating composition comprising a thermoplastic polymer and a liquid carrier to dissolve the thermoplastic polymer in the liquid carrier and form a heated coating solution; applying a liquid electrophotographic ink composition to a substrate to form a liquid electrophotographically printed layer on the substrate; and applying the heated coating solution to the liquid electrophotographically printed layer disposed on the substrate.

In some examples, prior to applying the LEP ink composition to the substrate, a primer composition is applied to the substrate. In some examples, the liquid electrophotographic printing process comprises heating a coating composition comprising a thermoplastic polymer and a liquid carrier to dissolve the thermoplastic polymer in the liquid carrier and form a heated coating solution; applying a primer composition to a substrate; applying a liquid electrophotographic ink composition to the substrate to form a liquid electrophotographically printed layer on the substrate; and applying the heated coating solution to the liquid electrophotographically printed layer disposed on the substrate.

In some examples, the heated coating composition is applied to the liquid electrophotographically printed layer (sometimes referred to herein as the printed layer) directly after the liquid electrophotographic ink composition is applied to the substrate.

In some examples, applying the LEP ink composition to the substrate comprises contacting the LEP ink composition with a latent electrophotographic image on a surface (for example, a photoimaging plate) to form a developed image and transferring the developed image to the substrate to form an LEP printed layer disposed on the substrate.

In some examples, applying the LEP ink composition to the substrate comprises contacting the LEP ink composition with a latent electrophotographic image on a surface to form a developed image; transferring the developed image to an intermediate transfer member and then transferring the developed image from the intermediate transfer member to the substrate to form an LEP printed layer disposed on the substrate. In some examples, this process is repeated for each of the coloured ink layers to be included in the final image.

In some examples, the heated coating solution is applied to the LEP printed layer (the printed layer) by contacting a coating applicator to the printed layer. In some examples, the substrate passes through a liquid electrophotographic printing station before passing through a coating application station. In some examples, the substrate passes directly from the liquid electrophotographic printing station to the coating application station.

In some examples, the heated coating composition is applied to the liquid electrophotographically printed substrate by using rod coating, gravure coating, roll coating, flexographic printing, lithography, blade coating, slot die coating, curtain coating, air knife coating, or extrusion coating. In some examples, the coating application station comprises a rod coating device, a gravure printing device, a roll coating device, a flexographic printing device, a lithography device, a blade coating device, a slot die coating device, a curtain coating device, an air knife coating device, or an extrusion coating device.

In some examples, the liquid electrophotographic printing process comprises heating a coating composition to form a heated coating solution; applying the heated coating solution to a liquid electrophotographically printed substrate; and cooling the heated coating solution, precipitating the thermoplastic resin from the liquid carrier and forming a coating layer disposed on the liquid electrophotographically printed layer.

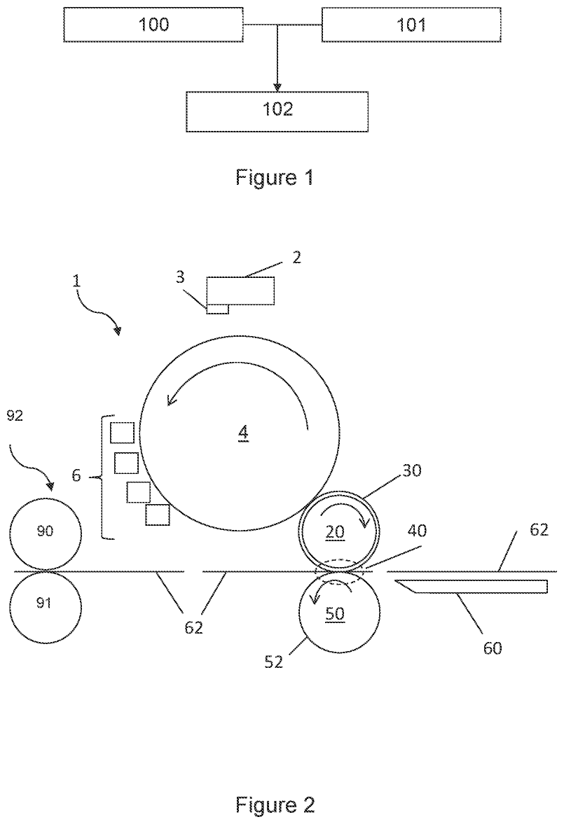

FIG. 1 shows a schematic illustration of an example liquid electrophotographic printing process. The liquid electrophotographic printing process comprises applying an LEP ink composition to a substrate (100); heating a coating composition to form a heated coating solution (101); and applying the heated coating solution to the liquid electrophotographically printed substrate (102). In some examples, the coating solution is heated while the LEP ink composition is applied to the substrate.

### Liquid Electrophotographic Printer

In another aspect, there is provided a liquid electrophotographic printer. The liquid electrophotographic printer may comprise a heating system and a coating system. The heating system may be configured to heat a coating composition to form a heated coating solution. The coating applicator may be configured to apply the heated coating solution to a liquid electrophotographically printed substrate. The coating composition may be any coating composition described herein. The liquid electrophotographic printer may be configured to perform any liquid electrophotographic printing process described herein.

In some examples, the liquid electrophotographic printer comprises a heating system configured to heat a coating composition comprising a thermoplastic polymer and a liquid carrier to dissolve the thermoplastic polymer in the liquid carrier and form a heated coating solution; and a coating applicator configured to apply the heated coating solution to a liquid electrophotographically printed substrate. In some examples, the coating composition comprises a thermoplastic polymer selected from a copolymer of ethylene and an alk-1-ene and a copolymer of ethylene and 50 wt. % or less vinyl acetate; and a liquid carrier comprising a hydrocarbon, a silicone oil or a vegetable oil.

The liquid electrophotographic printer may comprise an in-line coating system. In some examples, the coating applicator may be configured to apply the heated coating solution to the LEP printed substrate directly.

In some examples, the liquid electrophotographic printer comprises an LEP ink applicator; a heating system and a coating applicator. The LEP printer may comprise an LEP ink applicator configured to apply an LEP ink composition to a substrate; a heating system configured to heat the coating composition and form the heated coating solution; and a coating applicator configured to apply the heated coating solution to the LEP printed substrate. In some examples, the LEP ink applicator is configured to apply an LEP ink composition to a substrate to form the LEP printed substrate and transfer the LEP printed substrate to the coating applicator, which is configured to apply the heated coating composition to the LEP printed substrate.

In some examples, the LEP ink applicator may comprise a photoimaging plate and optionally may comprise an intermediate transfer member.

FIG. 2 shows a schematic illustration of an example liquid electrophotographic printer 1 which may be used in the method described herein. In some examples, an image, including any combination of graphics, text and images, is communicated to the LEP printer 1. The LEP printer 1 includes a photocharging unit 2 and a photo-imaging cylinder 4. The image is initially formed on a photoimaging plate (also known as a photoconductive member), in this case in the form of photo-imaging cylinder 4, before being transferred to a release layer 30 of the intermediate transfer member (ITM) 20 which is in the form of a roller (first transfer), and then from the release layer 30 of the ITM 20 to substrate 62 (second transfer).

According to an illustrative example, the initial image is formed on rotating photo-imaging cylinder 4 by photo charging unit 2. Firstly, photo charging unit 2 deposits a uniform static charge on photo-imaging cylinder 4 and then a laser imaging portion 3 of photo charging unit 2 dissipates the static charges in selected portions of the image area on the photo-imaging cylinder 4 to leave a latent electrostatic image. The latent electrostatic image is an electrostatic charge pattern representing the image to be printed. Liquid electrophotographic ink is then transferred to photo-imaging cylinder 4 by binary ink developer (BID) units 6. The BID units 6 present a uniform film of liquid electrophotographic ink to photo-imaging cylinder 4. The liquid electrophotographic ink contains electrically charged particles which, by virtue of an appropriate potential on the electrostatic image areas, are attracted to the latent electrostatic image on photo-imaging cylinder 4. The liquid electrophotographic ink does not adhere to the uncharged, non-image areas and forms a developed toner image on the surface of the latent electrostatic image. Photo-imaging cylinder 4 then has a single colour ink image on its surface.

The developed toner image is then transferred from photo-imaging cylinder 4 to release layer 30 of ITM 20 by electrical forces. The image is then dried and fused on release layer 30 of ITM 20 before being transferred from release layer 30 of ITM 20 to a substrate disposed on impression cylinder 50. The process may then be repeated for each of the coloured ink layers to be included in the final image.

The image is transferred from photo-imaging cylinder 4 to ITM 20 by virtue of an appropriate potential applied between photo-imaging cylinder 4 and ITM 20, such that the charged ink is attracted to ITM 20.

Between the first and second transfers, the solid content of the developed toner image is increased and the ink is fused on to ITM 20. For example, the solid content of the developed toner image deposited on release layer 30 after the first transfer is typically around 20%, by the second transfer the solid content of the developed toner image is typically around 80-90%. This drying and fusing is typically achieved by using elevated temperatures and airflow-assisted drying. In some examples, ITM 20 is heatable.

The substrate 62 (e.g., a sheet of, for example, paper) is fed into the LEP printer 1 by substrate feed tray 60 and is disposed on impression cylinder 50. As the substrate contacts ITM 20, the LEP ink composition is transferred to the substrate to form the liquid electrophotographically printed layer disposed on the substrate.

The LEP printed substrate is then fed into coating applicator 92. In FIG. 2, a roll coating device is shown comprising coating cylinder 90 and impression cylinder 91. As the LEP printed substrate contacts coating cylinder 90, the heated coating solution is transferred to the LEP printed substrate to form a coating layer disposed on the LEP printed layer disposed on the substrate.

In some examples, an alternative coating applicator 92 may be used. In some examples, the coating applicator 92 may comprise a rod coating device, a gravure printing device, a roll coating device, a flexographic printing device, a lithography device, a blade coating device, a slot die coating device, a curtain coating device, an air knife coating device, or an extrusion coating device.

Before the heated coating solution is transferred to the LEP printed substrate, the coating composition is heated by the heating system. In the device shown in FIG. 2, the heating system heats the coating composition to form the heated coating solution and contacts the heated coating solution with coating cylinder 90 of the coating applicator for application to the LEP printed substrate.

In some examples, the LEP printer may further comprise a priming system (not shown). The priming system may apply a primer composition to a substrate and feed the primed substrate into the LEP ink applicator.

In some examples, as substrate 62 contacts ITM 20, a single colour image is transferred to substrate 62. To form a single colour image (such as a black and white image), one pass of substrate 62 through nip 40 (between impression cylinder 50 and ITM 20) completes the image. For a multiple colour image, substrate 62 may be retained on the impression cylinder 50 and make multiple contacts with ITM 20 as it passes through nip 40. At each contact an additional colour plane may be placed on substrate 62. Alternatively, for a multiple colour image, the multicolour image may be formed on ITM 20 by applying multiple different LEP ink compositions of different colours to ITM 20 and then transferring the multicolour image to substrate 62 in a single pass of the substrate through nip 40.

### EXAMPLES

The following illustrates examples of the methods and other aspects described herein. Thus, these Examples should not be considered as limitations of the present disclosure, but are merely in place to teach how to make examples of the present disclosure.

### Materials

### LEP Ink Composition

ElectroInk™ 4.5: an LEP ink composition comprising chargeable particles comprising a pigment and a mixture of a copolymer of ethylene and acrylic acid and a copolymer of ethylene and methacrylic acid dispersed in Isopar L™ as the carrier liquid (available from HP Indigo).

### Carrier Liquid

Isopar L™: an isoparaffinic oil comprising a mixture of 011-013 isoalkanes (produced by ExxonMobil™; CAS number 64742-48-9).

### Thermoplastic Polymers

SK883: a polyolefin plastomer comprising a copolymer of ethylene and oct-1-ene (available from SK Global Chemical) with a melting point of 68° C. and a melt flow index of 3 g/10 min.

Queo 8203: a polyolefin plastomer comprising a copolymer of ethylene and oct-1-ene (available from Borealis) with a melting point of 74° C. and a melt flow index of 3 g/10 min.

Queo 0203: a polyolefin plastomer comprising a copolymer of ethylene and oct-1-ene (available from Borealis) with a melting point of 96° C. and a melt flow index of 3 g/10 min.

Escorene Ultra 00328 (EVA328): a copolymer of ethylene and 27 wt. % vinyl acetate (available from ExxonMobil™) with a melting point of 72° C. and a melt flow index of 3 g/10 min.

Elvax 410: a copolymer of ethylene and 18 wt. % vinyl acetate (available from Dow Inc.) with a melting point of 73° C. and a melt flow index of 500 g/10 min.

Elvax 40W: a copolymer of ethylene and 40 wt. % vinyl acetate (available from Dow Inc.) with a melting point of 47° C. and a melt flow index of 52 g/10 min.

Elvaloy AC 2116: a copolymer of ethylene and ethyl acrylate (available from Dow Inc.) with a melting point of 96° C. and a melt flow index of 1 g/10 min.

Nucrel™ 599 (Resin D): a copolymer of ethylene and methacrylic acid (available from DuPont™) with a melting point of 96° C. and a melt flow index of 450 g/10 min.

Fusabond C190: an anhydride modified ethylene vinyl acetate copolymer (available from DuPont™) with a melting point of 71° C. and a melt flow index of 16 g/10 min.

Lotryl 35BA: a random copolymer of ethylene and 35 wt. % butyl acrylate (available from Arkema™) with a melting point of 66° C. and a melt flow index of 35 g/10 min.

WB Varnish: TERRAWET™ Gloss Coating G 9/305 (available from Actega™)

### Additives

Incromold™ K-BE-(HU): a low melting point wax (available from Croda™).

Lumiflon™: a fluoropolymer resin based on fluoroethylene and vinyl ether monomers (available from AGC Chemicals™)

### Example Coating Compositions

The thermoplastic polymer (granules) was weighed (5 wt. % in final solution) in a glass flask and Isopar L was added (95 wt. %). The flask was placed on a hot plate and the mixture was mixed using a magnetic stirrer while heating until a translucent homogeneous solution (the heated coating composition) was obtained. Alternatively, the polymer can be dissolved in Isopar L by heating in an oven at 90° C. for several hours.

A variety of different coating compositions were produced by combining different polymers with Isopar L at 5 wt. % or 10 wt. % polymer. Tests were performed to determine the temperature at which the composition became clear. The samples were placed in metallic jackets and heated on a heating plate to the temperature at which the polymer material is completely dissolved (swells) in oil. A heating rate of approximately 10° C./min was used. The translucency was determined visually. The heated coating compositions were then cooled to determine the Cloud Point (T clouding in Table 1) by following the procedure described in ASTM D2500-05. The results are shown in Table 1. The temperature at which the composition becomes clear is generally 50-80° C. higher than the cloud point.

TABLE 1

| | | Melting | MI | 5 wt. % in Isopar L | | 10 wt. % in Isopar L | |
|---|---|---|---|---|---|---|---|
| | | point | [g/10 | T clear | T | T clear | T |
| Material | Polymer | [° C.] | min] | solution | clouding | solution | clouding |
| 1 | SK883 | 68 | 3 | 130 | 48 | 135 | 48 |
| 2 | Queo8203 | 74 | 3 | 135 | 49 | 132 | 50 |
| 3 | Elvax250 | 70 | 25 | 90 | 35 | — | — |
| 4 | Queo0203 | 96 | 3 | 120 | 62 | 120 | 67 |
| 5 | Elvaloy AC | 96 | 1 | 125 | 55 | 127 | 57 |
| | 2116 | | | | | | |
| 6 | Resin D | 98 | 450 | 130 | — | 130 | — |
| | | | | (cloudy) | | (cloudy) | |
| 7 | Elvax 410 | 73 | 500 | 110 | 38 | 110 | 42 |
| 8 | Elvax40W | 47 | 52 | 110 | 50 | 120 | 55 |
| 9 | EVA 328 | 72 | 3 | 90 | 33 | 90 | 35 |
| 10 | Fusabond | 71 | 16 | 132 | 54 | 131 | 60 |
| | C190 | | | | | | |
| 11 | Lotryl | 66 | 35 | 120 | 47 | 125 | 49 |
| | 35BA | | | | | | |

Several printed substrates were then produced by the following method. A solid CYAN image was printed (using cyan ElectroInk™ 4.5 at 400% coverage) on a paper substrate (Condat™ 115 g/m²) with an HP Indigo 7000 LEP printing press. The heated coating solution (maintained at approximately 60° C.) was then applied to the LEP printed image by using a wire coating rod on a semi-automatic coater (RK-K303 Multi-coater) at a speed of 9 m/min.

After coating, the printed substrate was placed in a hot oven at 90° C. for 5 min. The printed substrates were tested by using the standard Sutherland rub test (ASTM D5264) and the Taber Shear/Scratch test (using a TABER™ Shear/Scratch Tester Model 551 (with a 50 g weight and a speed of 5 rpm). A non-standard “fingernail test” (scratching was performed using a fingernail) was also performed. The gloss level of the prints before and after coating was measured by using a glossmeter Microgloss 75° by using the process described in ASTM D3679.

Melting points were determined by differential scanning calorimetry and correspond to the peak of the melting temperature range.

The melt flow rate (melt flow index) was measured by following the procedure described in ASTM D1238, using a temperature of 190° C. and a load of 2.16 kg.

The coat weight (of the overprint varnish layer) was determined by the “wet” coating method in which the dry coat weight of the layer=[(weight of coated wet substrate)−(weight of substrate before coating)]×100%÷(wt. % solids of the coating composition).

The results of these tests are shown in Table 2.

TABLE 2

| | | | | | Sutherland | | |
|---|---|---|---|---|---|---|---|
| | | | | | Rub test* | | |
| | polymer (5 wt. % | | No. of | CW | (% ink | | Gloss |
| | in hot Isopar L) | Rod# | layers | [gsm] | remaining) | Scratch** | (GU) |
| 1 | sk883 | 2 | 1 | 0.15 | 80 | moderate | 70 |
| | | 2 | 2 | ~0.3 | 96.5 | good | 78 |
| | | 5 | 1 | 0.39 | 97.5 | good | 88 |
| 2 | Q8203 | 2 | 1 | 0.11 | 70.3 | moderate | 68 |
| | | 2 | 2 | ~0.22 | 95 | good | 74 |
| | | 5 | 1 | 0.41 | 100 | — | 87 |
| 3 | Elv250 | 2 | 1 | 0.14 | 73 | bad | — |
| | | 2 | 2 | ~0.28 | 90 | moderate | — |
| | | 5 | 1 | 0.4 | 99 | — | 85 |
| Ref. 1 | El 4.5 (uncoated, | — | — | — | 75 | bad | 70 |
| | unheated) | | | | | | |
| Ref. 2 | El 4.5 (uncoated, | — | — | — | 85 | bad | 75 |
| | heated) | | | | | | |
| Ref. 3 | WB varnish | 1 | 1 | 1.3 | 100 | moderate | 86 |
| | | 5 | 1 | 4 | 99 | good | 88 |

*performed using a 9 μm rubbing paper.
**Taber test - Visual appearance

As shown in these Examples, the application of a heated coating composition comprising a copolymer of ethylene and an alk-1-ene or a copolymer of ethylene and vinyl acetate (e.g., 50 wt. % vinyl acetate or less) significantly improves the rub and scratch resistance of the LEP printed images.

### Results Summary

Tests have shown that the copolymers of ethylene and alk-1-ene and of ethylene and 50 wt. % or less vinyl acetate can be dissolved in Isopar L and can be maintained as a solution at a temperature of 60 to 70° C. to form a heated coating solution. When maintained at a temperature of 50 to 60° C., these coating solutions remain stable for a long period of time and can be applied to an LEP printed image by using standard coating equipment. The Isopar L is partially evaporated immediately after the coating solution is applied to the printed image, forming a transparent film. Final film curing can then be achieved by an additional heating step (at, for example, 80 to 90° C. for 1 to 5 min).

The best performance was seen for coating compositions comprising a thermoplastic polymer selected from a copolymer of ethylene and an alk-1-ene and a copolymer of ethylene and 50 wt. % or less vinyl acetate with a melting point range of between 60° C. and 75° C. and a melt flow index of less than 5 g/10 min. Indeed, thermoplastic polymers with a relatively low melting point (65 to 75° C.) and a low cloud point in Isopar L (50° C. or less) provided the best results (materials number 1-3 and 7-11).

Tests were performed by using coating compositions with a polymer concentration of 5-10 wt. %, which gave a solution viscosity of about 32 cP. The solution viscosity (dynamic viscosity) was measured using a TA HR-20 Hybrid Rheometer with a 50 mm spindle at 60° C. over 10 minutes. Coating compositions with a higher concentration of thermoplastic polymer may result in a higher viscosity solution and rapid precipitation, which may result in inefficient coating of the printed substrate.

The best results were seen for materials 1-3 [SK883 (melting point: 68° C., melt flow index 3 g/10 min), Queo 8203 (melting point: 74° C., melt flow index 3 g/10 min) and Escorene Ultra 00328 (melting point 73° C., melt flow index 3 g/10 min)]. Other copolymers were also tested, such as ethylene-co-maleic anhydride, ethylene-co-acrylates, and ethylene-co-methacrylates.

Without wishing to be bound by theory, it is believed that the coating composition provides a sacrificial layer that is damaged during mechanical wear instead of the LEP ink layer. As the molecular weight of the protective polymer is higher (i.e., the melt flow rate is lower), the layer is more resilient/stronger than a protective polymer with a low M_{w}. It is believed that materials 7, 8, and 11 were not as effective at protecting the LEP ink layer from rub/scratch due to their higher melt flow index, while it is believed that materials 3 and 10 had only a moderate effect on ink protection because these materials had a higher melt flow rate than materials 1 and 2.

Table 2 demonstrates the effect of coating layer thickness (coat weight) on the protection provided by the coating compositions. Surprisingly, good protection is achieved by using these coating compositions at relatively low coat weights of 0.4 to 0.5 g/m². For comparison, water-based varnishes and UV-cured varnishes are generally used at coat weights of 2 to 4 g/m² or more to achieve similar protection.

### Effect of Additives

The effect of incorporating a surface-active wax or a fluoropolymer additive was also tested.

It was found that the addition of low melting point waxes (such as Incromold) at a concentration of 2.5 wt. % to the coating compositions (containing, e.g., material #1) further improved the durability of the printed ink composition. Without wishing to be bound by theory, it is believed that the added protection may be due to an increased slip level on the surface.

It was found that the addition of a fluoropolymer (Lumiflon) to the coating composition had no noticeable effect on the durability of the printed ink composition. However, the fluoropolymer showed good compatibility with the copolymers dissolved in Isopar L and these coatings reduced the gloss of the coated substrates. As a result, a fluoropolymer can be added to the coating composition to limit the gloss of the printed ink, producing matte coatings that have a similar appearance to the uncoated ink layers.

Thus, it was found that the addition of a wax additive further improves the rub resistance provided by the coating composition while the addition of a fluoropolymer allows to the matte/gloss appearance to be adjusted.

While the invention has been described with reference to certain examples, those skilled in the art will appreciate that various modifications, changes, omissions, and substitutions can be made without departing from the spirit of the disclosure. It is intended, therefore, that the invention be limited by the scope of the following claims and their equivalents. Unless otherwise stated, the features of any dependent claim can be combined with the features of any of the other dependent claims and any of the independent claims.

1. A liquid electrophotographic printing process comprising:
heating a coating composition comprising a thermoplastic polymer and a liquid carrier to dissolve the thermoplastic polymer in the liquid carrier and form a heated coating solution;
wherein the thermoplastic polymer is selected from a copolymer of ethylene and an alk-1-ene and a copolymer of ethylene and 50 wt. % or less vinyl acetate; and
wherein the liquid carrier comprises a hydrocarbon, a silicone oil or a vegetable oil; and
applying the heated coating solution to a liquid electrophotographically printed layer disposed on a substrate.

2. The liquid electrophotographic printing process of claim 1, wherein the thermoplastic polymer has a melting point of 75° C. or less.

3. The liquid electrophotographic printing process of claim 1, wherein the thermoplastic polymer has a melt flow rate of 5 g/10 min or less.

4. The liquid electrophotographic printing process of claim 1, wherein the thermoplastic polymer is the copolymer of ethylene and an alk-1-ene.

5. The liquid electrophotographic printing process of claim 1, wherein the alk-1-ene is octene.

6. The liquid electrophotographic printing process of claim 1, wherein the copolymer of ethylene and 50 wt. % or less vinyl acetate is a copolymer of ethylene and from about 18 wt. % to about 40 wt. % vinyl acetate.

7. The liquid electrophotographic printing process of claim 1, wherein the coating composition is heated to a temperature of from about 60° C. to about 70° C. to form the heated coating composition.

8. The liquid electrophotographic printing process of claim 7, wherein the heated coating composition is applied to the liquid electrophotographically printed layer disposed on the substrate at a temperature of at least 50° C.

9. The liquid electrophotographic printing process of claim 1, wherein the liquid carrier comprises a hydrocarbon.

10. The liquid electrophotographic printing process of claim 1 further comprising applying a liquid electrophotographic ink composition to the substrate to form the liquid electrophotographically printed layer disposed on the substrate.

11. A liquid electrophotographic printing kit comprising:
a liquid electrophotographic ink composition; and
a coating composition comprising:
a thermoplastic polymer selected from a copolymer of ethylene and an alk-1-ene and a copolymer of ethylene and 50 wt. % or less vinyl acetate; and
a liquid carrier comprising a hydrocarbon, a silicone oil or a vegetable oil.

12. The liquid electrophotographic printing kit of claim 11, wherein the thermoplastic polymer has a melting point of 75° C. or less and a melt flow rate of 5 g/10 min or less.

13. The liquid electrophotographic printing kit of claim 11, wherein the liquid electrophotographic ink composition comprises:
a thermoplastic resin selected from a copolymer of an alkylene monomer and a monomer selected from acrylic acid and methacrylic acid; and
a liquid carrier comprising a hydrocarbon, a silicone oil or a vegetable oil; and
wherein the liquid carrier of the coating composition and the liquid carrier of the liquid electrophotographic ink composition are the same.

14. A liquid electrophotographic printer comprising:
a heating system configured to heat a coating composition comprising a thermoplastic polymer and a liquid carrier to dissolve the thermoplastic polymer in the liquid carrier and form a heated coating solution; and
a coating applicator configured to apply the heated coating solution to a liquid electrophotographically printed substrate;
wherein the coating composition comprises:
a thermoplastic polymer selected from a copolymer of ethylene and an alk-1-ene and a copolymer of ethylene and 50 wt. % or less vinyl acetate; and
a liquid carrier comprising a hydrocarbon, a silicone oil or a vegetable oil.

15. The electrophotographic printer of claim 14, wherein the substrate is passed directly from a liquid electrophotographic ink applicator to the coating applicator.
